(19) United States
(12) Patent Application Publication
(10) Pub. No.: US 2024/0208878 A1
(43) Pub. Date: Jun. 27, 2024

(54) SULFUR GRANULE WITH IMPROVED CRUSH STENGTH

(71) Applicant: Tessenderlo Group NV, Brussels (BE)

(72) Inventors: Joshua Randall Raymond, Phoenix, AZ (US); Harry Charles Kominski, Phoenix, AZ (US)

(73) Assignee: Tessenderlo Group NV, Brussels (BE)

(21) Appl. No.: 18/145,046

(22) Filed: Dec. 22, 2022

(51) Int. Cl. C05D 9/00; C05G 5/12

(52) U.S. Cl. CPC C05D 9/00; C05G 5/12

(57) ABSTRACT

The present invention relates to sulfur fertilizer granules having a sulfur content of at least 90 wt. % and a crush strength of at least 3.0 kgf. The present invention further relates to methods for the production of sulfur fertilizer granules by rotary drum granulation employing specific temperatures and water feed rates to achieve stable production of said sulfur fertilizer granules.

### FIELD OF THE INVENTION

The present invention relates to sulfur fertilizer granules. The present invention further relates to methods for the production of sulfur fertilizer granules by rotary drum granulation.

### BAKGROUND ART

Sulfur is part of the so-called secondary plant nutrients and like the primary nutrients (NPK), is essential for plant health and growth, although in lesser amounts than the primary nutrients. Sulfur is termed as the secondary nutrient only to refer to its quantity, not its importance in the healthy growth of the plants and crops. Sulfur is essential for nitrogen fixation in nodules on legumes, and it is necessary in the formation of chlorophyll. Plants use sulfur for producing proteins, amino acids, enzymes, and vitamins for a healthy growth. Sulfur generates resistance to disease. Most of the sulfur in soils is found in soil in organic matter. However, it is not available to plants in this form. In order to become available to plants, the sulfur must be first released from the organic matter and go through a mineralization process. The mineralization process is a result of microbial activity. In this process sulfur is converted to the sulphate form (SO₄²⁻), which is readily available to plants. Oil crops, legumes, forages and some vegetable crops require sulfur in considerable amounts. In many crops, its amount in the plant is similar to phosphorus. Although it is considered a secondary nutrient, it is now becoming recognized as the ‘fourth macronutrient’, along with nitrogen, phosphorus and potassium. Sulfur deficiency symptoms show up as light green to yellowish color. Deficient plants are small and their growth is retarded. Symptoms may vary between plant species. For example, in corn, sulfur deficiency shows up as interveinal chlorosis; in wheat, the whole plant becomes pale while the younger leaves are more chlorotic; in potatoes, spotting of leaves might occur.

The nutrient sulfur may be provided to the plant in many forms, including as a (bi)sulfate, thiosulfate, polysulfide, (bi)sulfite, elemental sulfur etc. In some applications, the provision of the nutrient sulfur in the form of elemental sulfur is desirable. In view of the complications and hazards associated with handling elemental sulfur powder, elemental sulfur fertilizer is generally applied in flaked, granular or pastille form. Due to its production process, a granule is essentially spherical, while a pastille generally has a flat bottom and a dome-shaped top. Although a significant portion of market share is dedicated to pastilles, in terms of handling and spreading properties granules are more advantageous.

The production of sulfur granules through rotary drum granulation is known in the art. Drum granulation uses atomizing nozzles to spray liquid sulfur and cooling water. The sulfur is cooled and solidified under influence of the cooling water. The inner wall of the drum is provided with inwardly extending lifting flights, whereby rotation of the drum causes the flights to lift solid sulphur particles from the bed of the granulation drum to an upper zone in the drum and to then drop the particles so that a curtain of solid sulphur particles fall toward the bed. With the rotation of the drum, the spherical sulfur particles are continuously picked up and grown under the influence of the liquid sulfur spray until the granulation is completed.

Controlling the rotary drum granulation of sulfur to achieve the desired particle size tends to be complicated, in a typical steady-state operation up to 50-60 wt. % of the granules produced are outside the desired particle size range and need to be reprocessed, which reduces the production capacity of the drum. Consequently, rotary drum granulators for sulfur fertilizer have an “oversized” footprint due to their low efficiency.

The crush strength of sulfur fertilizer granules or pastilles is an important factor which influences breakage and dust formation during transportation and handling. Achieving a high crush strength is especially challenging for sulfur fertilizers since the industrial-scale production processes typically result in amorphous sulfur (while mineral fertilizers may take a crystalline or semi-crystalline form).

The problems outlined above, in particular the challenge of providing high crush strength granules, are particularly present when a swelling clay is included in the sulfur fertilizer.

The present inventors have identified that it would be desirable to provide improved sulfur fertilizer granule production methods, as well as the resulting granules, which are characterized by having a high crush strength and efficient processing, requiring little rework of off-spec material (in particular granules outside targeted size range). In particular in case a swelling clay is included in the sulfur fertilizer granules.

WO2009/155682A1 discloses a method for the granulation of sulfur in a rotating drum.

U.S. Pat. No. 6,749,659B1 discloses a method for the granulation of a fertilizer comprising sulfur, clay and an additional fertilizer material.

U.S. Pat. No. 4,507,335A discloses an apparatus for producing sulfur granules comprising a seed generation and product growth zone.

It is an object of the present invention to provide sulfur fertilizer, in particular sulfur fertilizer comprising a swelling clay, having an improved crush strength.

It is an object of the present invention to provide an improved sulfur fertilizer manufacturing process which minimizes rework, in particular when a swelling clay is included in the sulfur fertilizer.

### SUMMARY OF THE INVENTION

The present inventors have found an optimized sulfur granule production process which achieves one or more objects of the invention. It was found that by careful control of the molten sulfur stream temperature, as well as the relative feed rates of molten sulfur and cooling water streams in a rotary drum granulation process, sulfur fertilizer granules comprising at least 90 wt. % (by total weight of the granule) of sulfur and having a crush strength of at least 3.0 kgf can be provided. As is shown in the appended examples, the methods described herein also result in significantly less rework of off-spec material, in particular in case granule size of 2-4 mm is targeted. The obtained granules do not only have a high crush strength but also exhibit low friability, high hardness, are free flowing/non-sticking and maintain these properties after prolonged storage in humid atmosphere. In view of these advantageous properties, the obtained granules also do not require any dedusting oil coating (although it may be applied).

Hence, in a first aspect, the present invention provides a sulfur fertilizer granule comprising at least 90 wt. % (by total weight of the granule) of sulfur and having a crush strength of at least 3.0 kgf.

In a preferred embodiment, the sulfur fertilizer granule has a diameter within the range of 2 to 4 mm.

In a preferred embodiment the sulfur fertilizer granule further comprises a clay mineral, preferably a clay material selected from kaolinites, illites, smectites and montmorillonites. In a highly preferred embodiment, the clay mineral is bentonite.

The sulfur fertilizer granule preferably comprises 90-95 wt. % (by total weight of the granule) sulfur.

In a further aspect of the invention, there is provided a method for the production of a sulfur fertilizer granule comprising the following steps:
(a) providing a molten sulfur stream comprising at least 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;
   characterized in that
   the molten sulfur stream of step (a) is fed to the rotary drum granulator in step (c) at a temperature within the range of 130-145° C.; and
   the ratio B:A is in the range of 0.018 to 0.068 liter/kg,
   wherein A is the feed rate of the molten sulfur stream (a), expressed in kg/minute,
   wherein B is the feed rate of the aqueous cooling stream (b), expressed in liter/minute.

In some embodiments, the method of the present invention further comprises step (a) with the steps:
(a1) providing sulfur;
(a2) providing the clay mineral; and
(a3) mixing the sulfur with the clay mineral at a temperature above the melting point of sulfur.

In a preferred embodiment, the step (a1) comprises providing molten sulfur and further comprises a step of degassing the molten sulfur in order to reduce the amount of H₂S in the molten sulfur.

In some embodiments, the method further comprises the step:
(e) recovering sulfur fertilizer granules from the rotary drum granulator.
   Preferably step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range.

In a highly preferred embodiment of the invention wherein step (e) is performed, the predetermined size range is 2-4 mm and the first fraction represents more than 80 wt. % of the recovered sulfur fertilizer granules.

### BRIEF DESCRIPTION OF THE FIGURES

The present invention will now be described in more detail with reference to specific embodiments of the invention, given only by way of illustration, and with reference to the accompanying drawings.

FIG. 1 is a schematic of the granulation process and shows an implementation of the process according to a preferred embodiment of the present invention wherein the molten sulfur stream comprises clay.

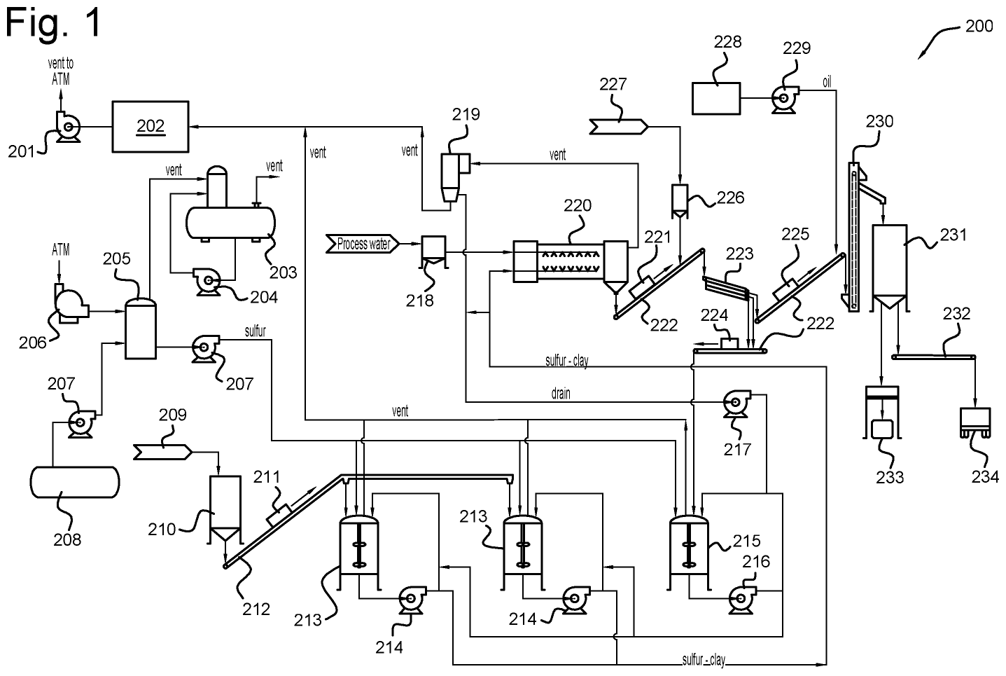

References: 200—process diagram, 201—exhaust fan, 202—wet scrubber, 203—sulfur vent scrubber, 204—sulfur vent scrubber pump, 205—sulfur degassing tank, 206—sulfur degasser blower, 207—sulfur pump, 208—sulfur tank, 209—bentonite from super sack, 210—clay feed hopper, 211—clay, 212—clay feed conveyor, 213—mix tank, 214—mix tank feed pump, 215—rework tank, 216—rework tank feed pump, 217—drain pump, 218—process water tank, 219—cyclone, 220—granulation drum, 221—sulfur-clay granules, 222—conveyor, 223—screen, 224—oversize/fines, 225—final product, 226—sulfur bentonite bag unloader, 227—clay from super sack, 228—oil tote, 229—oil treatment pump, 230—bucket elevator, 231—dry sulfur storage silo, 232—weigh feeder/conveyor, 233—super sack filing station, 234—sulfur-clay fertilizer truck loading.

### DESCRIPTION OF EMBODIMENTS

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, the features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound, unless explicitly defined otherwise.

The present invention will now be described in more detail with reference to specific embodiments of the invention, given only by way of illustration, and with reference to the accompanying drawings.

The term “sulfur” used in the context of the process and the sulfur fertilizer granule of the present invention is used to denote elemental sulfur, i.e. compounds consisting of sulfur in the oxidation state 0, typically in the form of S₈ molecules. The sulfur may originate from a refinery gas stream treated to produce elemental suflur e.g. via the Claus process. Alternatively, the sulfur may originate from a bio-based process (applied to a refinery gas stream or another precursor) which employs microorganisms such as bacteria to produce elemental sulfur. Such a bio-based production process of sulfur is known for example as THIOPAQ®.

The crush strength of a granule as referred to herein is preferably determined using a Torontech portable hardness tester TAB series, such as the portTAB-01.

### The Sulfur Fertilizer Granule and Compositions Comprising Said Granule

In a first aspect, the present invention provides a sulfur fertilizer granule comprising at least 90 wt. % (by total weight of the granule) of sulfur and having a crush strength of at least 3.0 kgf. In accordance with the invention, the granule is substantially spherical, as is obtainable by rotary drum granulation production of granules.

Such granules are obtainable by the production methods described herein. The present inventors have determined the average crush-strength on 30 pastilles of commercially available 90 wt. % sulfur product (Tiguer-Sul® 90CR) is 2.15 kgf. This crush strength was determined by side-to-side crushing, i.e. the weak side of the pastille. However, it is the weakest crush strength of a product which determines its overall performance. The granules according to the invention have a uniform crush strength and do not suffer from a “strong” side and a “weak” side.

The sulfur fertilizer granule preferably has a crush strength of at least 3.2 kgf, more preferably at least 3.4 kgf, most preferably at least 3.6 kgf.

The sulfur fertilizer granule preferably has a diameter within the range of 2 to 4 mm, preferably within the range of 2.5-4 mm.

In highly preferred embodiments of the invention, the sulfur fertilizer granule comprises a clay mineral. The clay mineral is preferably a swelling clay, such as a clay selected from kaolinites, illites, smectites and montmorillonites. The clay is most preferably bentonite. The sulfur fertilizer granule preferably comprises at least 4 wt. % (by total weight of the granule) of the clay mineral, preferably at least 8 wt. % (by total weight of the granule) of the clay mineral. Thus, the sulfur fertilizer granule preferably comprises at least 4 wt. % (by total weight of the granule) bentonite, preferably at least 8 wt. % bentonite.

In some embodiments of the invention, the sulfur fertilizer granule consists essentially of sulfur, such that the granule comprises at least 95 wt. % (by total weight of the granule) sulfur, preferably at least 98 wt. % (by total weight of the granule) sulfur, more preferably at least 99 wt. % (by total weight of the granule) sulfur.

In preferred embodiments of the invention, the sulfur fertilizer granules comprise clay as described herein earlier, and comprise 90-95 wt. % (by total weight of the granule) sulfur.

The sulfur fertilizer granule may comprise one or more further fertilizing ingredients, such as a source of macronutrients selected from N, P, K, S, Ca, or Mg and/or a source of micronutrients selected from Fe, B, Mn, Zn, Cu, Mo, Ni, V, Co. The sulfur fertilizer granule may also comprise a dedusting oil coating, such as a mineral, vegetable, seed and/or synthetic oils coating, preferably a vegetable oil coating. The present inventors have found that the granules obtainable by the process described herein do not require a dedusting oil coating to have acceptable dust levels. Hence, in some embodiments the fertilizer granule of the invention is essentially free of dedusting oil, such as essentially free of vegetable oil.

In general, the fertilizer granule will also comprise low amounts of moisture, and low amounts (typically <0.5 wt. %) of impurities other than sulfur, clay and optional further fertilizing ingredients.

Hence, as will be understood from the above, a particularly preferred sulfur fertilizer granule according to the invention is a sulfur fertilizer granule which:
comprises at least 90 wt. % (by total weight of the granule) of sulfur;
comprises at least 4 wt. % (by total weight of the granule) of a clay mineral, preferably bentonite;
has a diameter within the range of 2-4 mm;
has a crush strength of crush strength of at least 3.0 kgf, preferably at least 3.2 kgf, preferably of at least 3.4 kgf, more preferably of at least 3.6 kgf.
   Preferably there is provided a sulfur fertilizer granule which:
comprises 90-95 wt. % (by total weight of the granule) of sulfur;
comprises at least 4 wt. % (by total weight of the granule) of bentonite;
has a diameter within the range of 2-4 mm;
has a crush strength of crush strength of at least 3.0 kgf, preferably at least 3.2 kgf, preferably of at least 3.4 kgf, more preferably of at least 3.6 kgf.
   Preferably there is provided a sulfur fertilizer granule which:
comprises 90-95 wt. % (by total weight of the granule) of sulfur;
comprises at least 8 wt. % (by total weight of the granule) of bentonite;
has a diameter within the range of 2-4 mm;
has a crush strength of crush strength of at least 3.0 kgf, preferably at least 3.2 kgf, preferably of at least 3.4 kgf, more preferably of at least 3.6 kgf.

In preferred embodiments of the invention, the sulfur fertilizer granule has a moisture content of less than 0.3 wt. % (by total weight of the granule), preferably less than 0.2 wt. % (by total weight of the granule), more preferably less than 0.15 wt. % (by total weight of the granule), even more preferably less than 0.12 wt. % (by total weight of the granule).

A bulk composition comprising a plurality of the sulfur fertilizer granules described herein is also provided. The composition preferably comprises at least 50 wt. % (by total weight of the composition) of the sulfur fertilizer granules, preferably at least 75 wt. % (by total weight of the composition) of the sulfur fertilizer granules, more preferably at least 95 wt. % (by total weight of the composition) of the sulfur fertilizer granules. As will be understood by the skilled person, in case the sulfur fertilizer granules of the invention are mixed with another granular fertilizer at a 50:50 (w:w) ratio, then a bulk composition comprising about 50 wt. % (by total weight of the composition) of the sulfur fertilizer granules is obtained. Similarly, in case the sulfur fertilizer granules are simply produced and packaged as such, then a bulk composition comprising essentially 100 wt. % (by total weight of the composition) of the sulfur fertilizer granules is obtained. In some highly preferred embodiments of the invention there is provided a bulk composition which consists essentially of the sulfur fertilizer granules described herein. The bulk composition described herein may be packaged, e.g. in 50 kg bags, or in bulk bags (so called big-bags) having a volume of at least 0.6 m³. Alternatively, the bulk composition can be provided directly into the loading bed of a truck without including additional packaging.

In preferred embodiments of the invention, the composition described herein has a tapped bulk density of at least 1.1 kg/L, preferably at least 1.2 kg/L, more preferably at least 1.3 kg/L. The tapped bulk density is preferably in the range of 1.15-1.3 kg/L. This is particularly applicable if the bulk composition comprises at least 95 wt. % (by total weight of the composition) of the sulfur fertilizer granules, preferably if the bulk composition consists essentially of the sulfur fertilizer granules.

The preferred moisture content outlined herein earlier for the sulfur fertilizer granule is equally applicable to the bulk composition described herein. Hence the composition comprising a plurality of the sulfur fertilizer granules preferably has a moisture content of less than 0.3 wt. % (by total weight of the composition), preferably less than 0.2 wt. % (by total weight of the composition), more preferably less than 0.15 wt. % (by total weight of the composition), even more preferably less than 0.12 wt. % (by total weight of the composition). This is particularly applicable if the bulk composition comprises at least 95 wt. % (by total weight of the composition) of the sulfur fertilizer granules, preferably if the bulk composition consists essentially of the sulfur fertilizer granules.

The composition is preferably characterized by having an average crush strength, determined by testing the crush strength of 30 random granules from the composition and calculating the average crush strength, of at least 3.0 kgf, preferably at least 3.2 kgf, more preferably of at least 3.4 kgf, more preferably of at least 3.6 kgf. This is particularly applicable if the bulk composition comprises at least 95 wt. % (by total weight of the composition) of the sulfur fertilizer granules, preferably if the bulk composition consists essentially of the sulfur fertilizer granules.

### The Method for the Production of Sulfur Fertilizer Granules

In a further aspect of the invention, there is provided a method for the production of a sulfur fertilizer granule comprising the following steps:
(a) providing a molten sulfur stream comprising at least 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;
   characterized in that
   the molten sulfur stream of step (a) is fed to the rotary drum granulator in step (c) at a temperature within the range of 130-145° C.; and
   the ratio B:A is in the range of 0.018 to 0.068 liter/kg,
   wherein A is the feed rate of the molten sulfur stream (a), expressed in kg/minute,
   wherein B is the feed rate of the aqueous cooling stream (b), expressed in liter/minute.

The methods described herein allow the production of the high crush strength sulfur fertilizer granule described herein earlier. The sulfur fertilizer granule produced by this method, is thus preferably the sulfur fertilizer granule described herein earlier. In some embodiments of the invention the method described herein is thus a method for the production of a sulfur fertilizer granule having one or more of the properties described herein earlier (e.g. relating to its composition, crush strength, etc.).

The principle of rotary drum granulation is known to the skilled person and is described in detail in WO2009/155682A1, U.S. Pat. Nos. 6,749,659B1, and 4,507,335A, each of which are incorporated herein by reference.

In step (c) the molten sulfur stream (a) and the aqueous cooling stream (b) are sprayed through nozzles mounted in the interior of the rotary drum. The nozzle are preferably fan-type nozzles. The nozzles are preferably placed at a plurality of positions along the length of the rotary drum granulator. As is known to the skilled person, the drum of a rotary drum granulator is a substantially cylindrical vessel placed horizontally. The length of the drum runs along the horizontal plane. The bed of fertilizer granules is, due to the rotary action of the drum, moved along the length of the drum to an outlet of the drum (typically falling into an exit chute). The falling curtain of fertilizer particles grows in granule size as it moves through the drum and passes multiple spray nozzles spraying molten sulfur and aqueous cooling. The movement of the bed through the drum to the outlet is achieved by a slight inclination of the drum and/or the lay-out of the internal flights. In order to achieve stable granulation, the portion of the drum opposite to the outlet side may be continuously fed with seed material (typically recycled undersize granules or recycled oversize granules after crushing), although this is not strictly required as the spray nozzles may be finetuned to increase cooling and achieve seed generation in a zone of the drum (as is described in detail in WO2009155682A1). In the methods of the present invention it is preferred that seed material having a size of 2 mm or less is continuously fed to the granulation drum.

The cooling stream of step (b) is typically water, but does not need to be demineralized water. Lower purity grades of water such as process water, ground water, surface water, etc. can be used. The water content is preferably at least 96 wt. % (by total weight of the aqueous stream), the remaining 4 wt. % being minerals and other impurities.

In preferred embodiments, step (d) comprises rotating the drum at a rotation speed suitable to create a stable falling curtain of fertilizer granules. As will be understood by the person skilled in the art, each granulation drum typically has a window of drum speeds wherein a stable falling curtain of fertilizer granules can be achieved. Within this window, increased drum speed reduces the residence time inside the granulator and thus reduces the obtained particle size, and vice versa.

In a preferred embodiment of the invention, the molten sulfur stream of step (a) is fed to the rotary drum granulator in step (c) at a temperature within the range of 132-138° C. As is shown in the appended examples, lowering the temperature to this range has a large effect on the amount of rework required. Sulfur obtained from industrial processes (like the Claus process) comprises entrapped H₂S. The present inventors have found that degassing the sulfur before using it in the process of the present invention is important not only for health and safety reasons, but may affect the crush strength of the granules. Hence it is preferred that the sulfur comprised in the molten sulfur stream provided in step (a) has been subjected to a step of degassing the molten sulfur in order to reduce the amount of H₂S in the molten sulfur. In some embodiments, explained herein elsewhere, the method of the present invention includes a step of degassing the molten sulfur.

In preferred embodiments of the invention, the ratio B:A is in the range of 0.018 to 0.058 L/kg. In some embodiments of the invention, the ratio B:A is in the range of 0.018 to 0.027 L/kg. As is shown in the appended examples, this flow rate may further contribute to improving the amount of product within the range of 2-4 mm produced.

In a preferred embodiment, the aqueous cooling stream of step (b) is fed to the rotary drum granulator in step (c) at a temperature within the range of 20-50° C., preferably within the range of 25-45° C.

The inventors have found that specific ventilation of the drum is also relevant to achieve a stable production of high hardness granules. Hence, in preferred embodiments of the invention, the granulator is ventilated at a rate in the range of 250-600 V_{gran}/hour wherein V_{gran} is the interior granulator volume, preferably at a rate between 300 to 500 V_{gran}/hour, more preferably at a rate between 350 to 450 V_{gran}/hour. Ventilation can simply be performed using ambient air. Ventilation thus comprises forcing ambient air through the granulator, using a ventilator or other means known to the skilled person. The ventilation direction through the drum is not limiting and ventilation can be counter or concurrent to the movement of the bed. In some embodiments of the invention, the air stream exiting the granulator is treated to remove entrailed sulfur, H₂S and/or SO₂, for example using a venturi nozzle, a bag house, a jacketed cyclone or a packed bed reactor. The ambient air used for ventilation preferably has a temperature within the range of 5-50° C., preferably within the range of 20-50° C., more preferably within the range of 20-45° C.

The inventors have found that specific granulation bed temperatures are also relevant to achieve a stable production of high hardness granules. Granulation bed temperature is mostly controlled by controlling the sulfur stream temperature, cooling water temperature, and ventilation rates as explained herein before. In preferred embodiments of the invention, the granulator bed temperature is within the range of 60-75° C.

The methods of the invention preferably comprise the use of a granulator drum having an interior volume within the range of 12-16 m³ such as 13-15 m³ employing a feed rate of the molten sulfur stream of step (a) within the range of 8000-12000 kg/hour, preferably within the range of 9000-11000 kg/hour, more preferably within the range of 9500-10500 kg/hour.

In highly preferred embodiments of the invention, the molten sulfur stream of step (a) comprises a clay mineral. The clay mineral is preferably a swelling clay, such as a clay selected from kaolinites, illites, smectites and montmorillonites. The clay is most preferably bentonite. The the molten sulfur stream of step (a) preferably comprises at least 4 wt. % (by total weight of the stream) of the clay mineral, preferably at least 8 wt. % (by total weight of the stream) of the clay mineral. Thus, the the molten sulfur stream of step (a) preferably comprises at least 4 wt. % (by total weight of the stream) bentonite, preferably at least 8 wt. % bentonite.

In some embodiments of the invention, the molten sulfur stream of step (a) consists essentially of sulfur, such that the molten sulfur stream of step (a) comprises at least 95 wt. % (by total weight of the stream) sulfur, preferably at least 98 wt. % (by total weight of the stream) sulfur, more preferably at least 99 wt. % (by total weight of the stream) sulfur.

In preferred embodiments of the invention, the molten sulfur stream of step (a) comprises clay as described herein earlier, and comprises 90-95 wt. % (by total weight of the stream) sulfur.

In highly preferred embodiments, stream (a) consists essentially of sulfur and the clay wherein the combined amount of sulfur and clay by total weight of stream (a) is more than 98 wt. %, preferably 99 wt. % and most preferably more than 99.5 wt. %. In preferred embodiments, stream (a) consists essentially of sulfur and bentonite wherein the combined amount of sulfur and bentonite by total weight of stream (a) is more than 98 wt. %, preferably 99 wt. % and most preferably more than 99.5 wt. %.

As will be understood from the above, preferred embodiments of the method are provided wherein
the molten sulfur stream of step (a) is fed to the rotary drum granulator in step (c) at a temperature within the range of 130-145° C., preferably at a temperature within the range of 132-138° C.;
the ratio B:A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.; and
the granulator is ventilated at a rate in the range of 250-600 V_{gran}/hour wherein V_{gran}is the interior granulator volume, preferably at a rate between 300 to 500 V_{gran}/hour, more preferably at a rate between 350 to 450 V_{gran}/hour.
   Further preferred embodiments of the method if the invention, as will be understood from the above, are these wherein:
the molten sulfur stream of step (a) is fed to the rotary drum granulator in step (c) at a temperature within the range of 130-145° C., preferably at a temperature within the range of 132-138° C.;
the ratio B:A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.;
the granulator is ventilated at a rate in the range of 250-600 V_{gran}/hour wherein V_{gran}is the interior granulator volume, preferably at a rate between 300 to 500 V_{gran}/hour, more preferably at a rate between 350 to 450 V_{gran}/hour;
the molten sulfur stream of step (a) comprises a clay mineral, and comprises 90-95 wt. % (by total weight of the stream) sulfur.
   Further preferred embodiments of the method if the invention, as will be understood from the above, are these wherein:
the molten sulfur stream of step (a) is fed to the rotary drum granulator in step (c) at a temperature within the range of 130-145° C., preferably at a temperature within the range of 132-138° C.;
the ratio B:A is in the range of 0.018 to 0.068 liter/kg, preferably in the range of 0.018 to 0.058 L/kg;
the aqueous cooling stream of step (b) is fed to the rotary drum granulator in step (c) at a temperature within the range of 20-50° C., preferably within the range of 25-45° C.;
the granulator is ventilated at a rate in the range of 250-600 V_{gran}/hour wherein V_{gran}is the interior granulator volume, preferably at a rate between 300 to 500 V_{gran}/hour, more preferably at a rate between 350 to 450 V_{gran}/hour;
the molten sulfur stream of step (a) comprises at least 4 wt. % (by total weight of the stream) bentonite, preferably at least 8 wt. % bentonite, and comprises 90-95 wt. % (by total weight of the stream) sulfur.

In some embodiments of the invention, the method does not comprise the application of a dedusting oil as described herein earlier, such that the obtained sulfur fertilizer granule is essentially free of dedusting oils, in particular vegetable oil.

In some preferred embodiments of the invention, the method is provided wherein the molten sulfur stream of step (a) comprises a clay mineral and wherein step (a) comprises the steps:
(a1) providing sulfur;
(a2) providing the clay mineral; and
(a3) mixing the sulfur with the clay mineral at a temperature above the melting point of sulfur.

In preferred embodiments of the invention, step (a1) comprises a step of degassing the molten sulfur in order to reduce the amount of H₂S in the molten sulfur. Suitable degassing techniques include chemical degassing using catalyst beds, physical degassing with squash plates, mesh plates, mesh pads or spray nozzles, forcing air through the molten sulfur, or combinations thereof. In preferred embodiments, degassing comprises forcing air through the molten sulfur. The degassing is preferably performed until sampling of an air stream passed through the molten sulfur shows a H₂S concentration of less than 10 ppmv. Degassing is preferably performed in case the sulfur has been produced from refinery gas streams, in particular in case the sulfur has been produced via the Claus process.

In preferred embodiments, step (a3) is performed in a stirred tank. The stirred tank is preferably continuously stirred or agitated such that the clay remains suspended in the molten sulfur until it enters the granulator drum.

In preferred embodiments of the invention, the method further comprises the step:
(a) recovering sulfur fertilizer granules from the rotary drum granulator.

In preferred embodiments, step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range. In such embodiments, the predetermined size range is highly preferably from 2 to 4 mm in diameter. The granulation bed is discharged from the drum and conveyed to a size-separation operation configured to recover particles having a size within the predetermined size range. The size-separation operation preferably comprises double deck screening. In some embodiments of the invention, the second fraction and third fraction are returned to step (a) of the process for recycling. In case the predetermined size range is from 2 to 4 mm, the second fraction comprises particles below 2 mm in diameter, whilst the third fraction comprises particles above 4 mm in diameter.

The oversize fraction (the third fraction) can be submitted to crushing before it is returned to the granulator. However, preferably, the step of recycling the second and third fraction to step (a) of the process comprises remelting at least the third fraction, thereby avoiding a crushing step. Remelting can be performed in a dedicated rework tank, or in a tank receiving molten sulfur feed.

As is shown in the appended examples, the methods of the present invention minimize rework, in particular in case the predetermined size range is from 2 to 4 mm. Hence, in highly preferred embodiments of the invention, the first fraction represents more than 80 wt. % of the recovered sulfur fertilizer granules, preferably the first fraction represents more than 85 wt. % of the recoved sulfur fertilizer granules, and more preferably the first fraction represents more than 90 wt. % of the recoved sulfur fertilizer granules.

### Sulfur Fertilizer Granule Obtainable by the Method Described Herein.

In another aspect the invention provides a sulfur fertilizer granule obtainable by the method described herein. The sulfur fertilizer granule obtainable by the method described herein corresponds to the sulfur fertilizer granule described herein earlier, and thus preferably has one or more of the properties described herein earlier (e.g. relating to its composition, crush strength, etc.).

### Uses and Methods of the Sulfur Fertilizer Granule

In another aspect, the invention concerns the use of the sulfur fertilizer granule of the invention as a fertilizer. In an embodiment of the invention there is provided the use of the sulfur fertilizer granule of the invention for providing nutrients to plants. In particular, there is provided the use of the sulfur fertilizer granule of the invention for fertilization through broadcast application.

In another aspect, the invention concerns a method of fertilizing plants comprising application of the sulfur fertilizer granule of the invention, preferably application to soil. Application is preferably through broadcast application.

The invention is further described by the following aspects:
1. A sulfur fertilizer granule comprising at least 90 wt. % (by total weight of the granule) of sulfur and having a crush strength of at least 3.0 kgf.
2. The sulfur fertilizer granule of aspect 1 having a crush strength of at least 3.2 kgf.
3. The sulfur fertilizer granule of aspect 2 having a crush strength of at least 3.6 kgf.
4. The sulfur fertilizer granule of any one of the previous aspects having a diameter within the range of 2-4 mm.
5. The sulfur fertilizer granule of any one of the previous aspects further comprising a clay mineral.
6. The sulfur fertilizer granule of aspect 5 wherein the clay mineral is selected from kaolinites, illites, smectites and montmorillonites.
7. The sulfur fertilizer granule of aspect 6 wherein the clay mineral is bentonite.
8. The sulfur fertilizer granule of any one of the previous aspects comprising 90-95 wt. % (by total weight of the granule) sulfur.
9. The sulfur fertilizer granule of any one of the previous aspects, preferably aspect 8 comprising at least 4 wt. % (by total weight of the granule) bentonite.
10. The sulfur fertilizer granule of aspect 9 comprising at least 8 wt. % (by total weight of the granule) bentonite.
11. The sulfur fertilizer granule of any one of the previous aspects which further comprises a vegetable oil coating.
12. A composition comprising a plurality of sulfur fertilizer granules of any one of aspects 1-11.
13. The composition of aspect 12 comprising at least 50 wt. % (by total weight of the composition) of the sulfur fertilizer granules.
14. The composition of aspect 12 or 13 having a moisture content of less than 0.3 wt. % (by total weight of the composition).
15. The composition of any one of aspects 12-14 having a tapped bulk density of more than 1.1 kg/L.
16. A method for the production of a sulfur fertilizer granule comprising the following steps:
   (a) providing a molten sulfur stream comprising at least 90 wt. % (by total weight of the molten sulfur stream) sulfur;
   (b) providing an aqueous cooling stream;
   (c) continuously feeding the molten sulfur stream of step (a) and the aqueous cooling stream of step (b) to a rotary drum granulator;
   (d) continuously rotating the rotary drum granulator, thereby continuously forming sulfur fertilizer granules;
      characterized in that
      the molten sulfur stream of step (a) is fed to the rotary drum granulator in step (c) at a temperature within the range of 130-145° C.; and
      the ratio B:A is in the range of 0.018 to 0.068 liter/kg,
      wherein A is the feed rate of the molten sulfur stream (a), expressed in kg/minute,
      wherein B is the feed rate of the aqueous cooling stream (b), expressed in liter/minute.
17. The method of aspect 16 wherein the molten sulfur stream of step (a) is fed to the rotary drum granulator in step (c) at a temperature within the range of 132-138° C.
18. The method of aspect 16 or 17 wherein the sulfur comprised in the molten sulfur stream provided in step (a) has been subjected to a step of degassing the molten sulfur in order to reduce the amount of H₂S in the molten sulfur.
19. The method of any one of aspects 16-18 wherein the ratio B:A is in the range of 0.018 to 0.027 liter/kg.
20. The method of any one of aspects 16-19 wherein the granulator is ventilated at a rate in the range of 250-600 V_{gran}/hour wherein V_{gran} is the interior granulator volume.
21. The method of any one of aspects 16-20 wherein the granulator bed temperature is within the range of 65-75° C.
22. The method of any one of aspects 16-21 wherein the aqueous cooling stream of step (b) is fed to the rotary drum granulator in step (c) at a temperature within the range of 20-50° C.
23. The method of aspect 22 wherein the aqueous cooling stream of step (b) is fed to the rotary drum granulator in step (c) at a temperature within the range of 25-45° C.
24. The method of any one of aspects 16-23 wherein the molten sulfur stream comprises 90-95 wt. % (by total weight of the stream) sulfur.
25. The method of any one of aspects 16-24 wherein the molten sulfur stream further comprises a clay mineral.
26. The method of aspect 25 wherein the clay mineral is selected from kaolinites, illites, smectites and montmorillonites.
27. The method of aspect 26 wherein the clay mineral is bentonite.
28. The method of aspect 27 wherein the molten sulfur stream comprises at least 4 wt. % (by total weight of the stream) bentonite.
29. The method of aspect 28 wherein the molten sulfur stream comprises at least 8 wt. % (by total weight of the stream) bentonite.
30. The method of any one of aspects 16-29 wherein step (c) is performed using a plurality of spray nozzles placed at a plurality of positions along the length of the rotary drum granulator
31. The method of aspects 25-29 wherein step (a) comprises the steps:
   (a1) providing sulfur;
   (a2) providing the clay mineral; and
   (a3) mixing the sulfur with the clay mineral at a temperature above the melting point of sulfur.
32. The method of aspect 31 wherein the step (a1) comprises providing molten sulfur and further comprises a step of degassing the molten sulfur in order to reduce the amount of H₂S in the molten sulfur.
33. The method of aspect 32 wherein the degassing step comprises forcing air through the molten sulfur.
34. The method of any one of aspects 16-33 wherein the method further comprises the step:
   (e) recovering sulfur fertilizer granules from the rotary drum granulator.
35. The method of aspect 34 wherein step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range.
36. The method of aspect 35 wherein the predetermined size range is from 2 to 4 mm.
37. The method of aspect 35 or 36 wherein separating the recovered sulfur fertilizer granules into the first, second and third fraction comprises screening
38. The method of aspect 37 comprising screening using double deck screens.
39. The method of any one of aspects 35-38 wherein the second fraction and third fraction are returned to step (a) of the process for recycling.
40. The method of any one of aspects 35-39 35 wherein the first fraction represents more than 80 wt. % of the recovered sulfur fertilizer granules.
41. A sulfur fertilizer granule obtainable by the method of any one of aspects 16-40.
42. A method of fertilizing plants comprising application of the sulfur fertilizer granule of any one of aspects 1-15 or 41 to soil.

### EXAMPLES

### Example 1

In a rotary drum granulator having a volume of about 14 m³, a molten sulfur stream comprising 94.7 wt. % sulfur and about 5 wt. % bentonite was sprayed at a rate of 9979 kg/hour. The sulfur stream originated from a Claus process and was degassed to a H₂S content of the degassing air stream exiting the sulfur melt of less than 10 ppmv. The molten sulfur stream is fed to the rotary drum granulator at a temperature within the range of 132-138° C.

Water is sprayed in the rotary drum granulator at a rate of 204 L/hour and a temperature of 20-40° C.

Ventilation was applied at a rate of about 420 times the reactor volume per hour.

88 wt. % of the resulting particles were in the size range between 2 to 4 mm, whilst 8 wt. % had a particle size greater than 4 mm, and 4 wt. % had a size range below 2 mm. A random sampling of 30 granules within the size range of 2 to 4 mm showed an average hardness of 3.62 kgf as determined with the Torontech portTAB-01.

### Example 2

In a rotary drum granulator having a volume of about 14 m³, a molten sulfur stream comprising 92.4 wt. % sulfur and about 7.5 wt. % bentonite was sprayed at a rate of 9979 kg/hour. The sulfur stream originated from a Claus process and was degassed to a H2S content of the degassing air stream exiting the sulfur melt of less than 10 ppmv. The molten sulfur stream is fed to the rotary drum granulator at a temperature within the range of 132-143° C.

Water is sprayed in the rotary drum granulator at a rate of 295 L/hour and a temperature of 20-40° C.

Ventilation was applied at a rate of about 420 times the reactor volume per hour.

55 wt. % of the resulting particles were in the size range between 2 to 4 mm, whilst 10 wt. % had a particle size greater than 4 mm, and 35 wt. % had a size range below 2 mm. A random sampling of 30 granules within the size range of 2 to 4 mm showed an average hardness of 3.77 kgf as determined with the Torontech portTAB-01.

1. A sulfur fertilizer granule comprising at least 90 wt. % (by total weight of the granule) of sulfur and having a crush strength of at least 3.0 kgf.

2. The sulfur fertilizer granule of claim 1 having a crush strength of at least 3.6 kgf.

3. The sulfur fertilizer granule of claim 1 having a diameter within the range of 2-4 mm.

4. The sulfur fertilizer granule of claim 1 further comprising a clay mineral.

5. The sulfur fertilizer granule of claim 4 wherein the clay mineral is bentonite.

6. The sulfur fertilizer granule of claim 5 comprising 90-95 wt. % (by total weight of the granule) sulfur.

7. The sulfur fertilizer granule of claim 6 comprising at least 4 wt. % (by total weight of the granule) bentonite.

8. A composition comprising a plurality of sulfur fertilizer granules of claim 1.

9. A method for the production of a sulfur fertilizer granule comprising the following steps:
(a) providing a molten sulfur stream comprising at least 90 wt. % (by total weight of the molten sulfur stream) sulfur;
(b) providing an aqueous cooling stream;
(c) continuously feeding the molten sulfur stream of step (a) and the aqueous cooling stream of step (b) to a rotary drum granulator;
(d) continuously rotating the rotary drum granulator, thereby continuously forming sulfur fertilizer granules;characterized in that
the molten sulfur stream of step (a) is fed to the rotary drum granulator in step (c) at a temperature within the range of 130-145° C.; and
the ratio B:A is in the range of 0.018 to 0.068 liter/kg,
wherein A is the feed rate of the molten sulfur stream (a), expressed in kg/minute,
wherein B is the feed rate of the aqueous cooling stream (b), expressed in liter/minute.

10. The method of claim 9 wherein the molten sulfur stream of step (a) is fed to the rotary drum granulator in step (c) at a temperature within the range of 132-138° C.

11. The method of claim 9 wherein the sulfur comprised in the molten sulfur stream provided in step (a) has been subjected to a step of degassing the molten sulfur in order to reduce the amount of H₂S in the molten sulfur.

12. The method of claim 9 wherein the granulator is ventilated at a rate in the range of 250-600 V_{gran}/hour wherein V_{gran} is the interior granulator volume.

13. The method of claim 9 wherein the granulator bed temperature is within the range of 65-75° C.

14. The method of claim 9 wherein the aqueous cooling stream of step (b) is fed to the rotary drum granulator in step (c) at a temperature within the range of 20-50° C.

15. The method of claim 9 wherein the molten sulfur stream comprises 90-95 wt. % (by total weight of the stream) sulfur.

16. The method of claim 9 wherein the molten sulfur stream further comprises a clay mineral.

17. The method of claim 16 wherein the clay mineral is bentonite.

18. The method of claim 9 wherein the method further comprises the step:
(e) recovering sulfur fertilizer granules from the rotary drum granulator,
and wherein step (e) comprises separating the recovered sulfur fertilizer granules into a first fraction having a size within a predetermined size range, a second fraction having a size larger than the upper boundary of the predetermined size range and a third fraction having a size smaller than the lower boundary of the predetermined size range.

19. The method of claim 18 wherein the predetermined size range is from 2 to 4 mm.

20. The method of claim 19 wherein the first fraction represents more than 80 wt. % of the recovered sulfur fertilizer granules.
